(19) United States
(12) Patent Application Publication
(10) Pub. No.: US 2002/0068799 A1
(43) Pub. Date: Jun. 6, 2002

(54) Rubber composition

(76) Inventor: Kaneyoshi Hayashi, Saitama (JP)

Correspondence Address: LAW OFFICE OF JOHN A. GRIECCI, 2201 E. WILLOW ST, STE D, PMB 344, SIGNAL HILL, CA, 90806-2142, US

(21) Appl. No.: 09/981,541

(22) Filed: Oct. 15, 2001

(30) Foreign Application Priority Data
Oct. 16, 2000 (JP) 2000-315104
Sep. 20, 2001 (JP) 2001-287266

(51) Int. Cl. C08K 3/34

(52) U.S. Cl. 525/342; 524/445

(57) ABSTRACT

A rubber composition is provided from which a rubber with a sufficient strength to endure repeated bending and excellent chlorine resistance can be obtained.

The rubber composition contains at least a rubber component, polybutene and a white carbon.

### BACKGROUND OF THE INVENTION

1. Field of the Invention

The present invention relates to a rubber composition which can be preferably used as raw material for parts of water supply and drainage pipe lines (e.g. city water line) such as a rubber hose for water supply, a sealant and bendable pipe joints for water supply pipes.

2. Background Arts

In water supply and drainage pipe lines laid in buildings and a variety of facilities, parts such as rubber hoses for water supply and drainage, sealants and bendable joints for water supply and drainage pipes are used.

To sufficiently satisfy the demanded elasticity, these parts for water supply and drainage pipes have been conventionally composed of elastic and bendable materials such as rubber. Furthermore, in the case where pressure-resistance is required, to prevent ruptures, etc. tier cords composed of nylon and polyester, etc. or metallic wires have been buried in the above-described materials as reinforcement fibers.

Problems to be Solved by the Invention

These parts are required to be sufficiently flexible on one hand, and strong enough to endure the use as parts for water supply and drainage pipe lines on the other hand. However, converntional water supply and drainage pipe line parts, for example, rubber hoses for water supply and drainage are not sufficiently strong so that they tend to be cracked and damaged on repeated displacement.

Also, with the water pollution in recent years, in the situations where the concentration of sterilizing chlorine in tap water has become higher, deterioration due to chlorine has been one cause to reduce the strength of parts for water supply and drainage pipes.

### SUMMARY OF THE INVENTION

The present invention has been carried out in view of problems as described above, aiming at providing a rubber composition which is capable of producing the rubber having a sufficient strength to endure repeated displacement, and excellent chlorine resistance.

Means for Solving the Problems

To achieve the aforementioned purposes, a rubber composition according to the present invention is made sufficiently strong to endure repeated displacement, and resistant to chlorine by improving the composition of supplements.

More specifically, the present invention provides the following:

(1) a rubber composition comprising at least a rubber component, polybutene, and white carbon,

(2) a rubber composition as defined in the above (1) further comprising a silane coupler,

(3) a rubber composition as defined in the above (1) or (2) further comprising clay,

(4) a rubber composition as defined in any of the above (1) through (3) comprising adding 5˜60 parts by weight of polybutene and 5˜100 parts by weight of white carbon per 100 parts by weight of the rubber component and mixing them,

(5) a rubber composition as defined in the above (4) comprising further adding 0.5˜8 parts by weight of silane coupler and mixing them,

(6) a rubber composition as defined in the above (4) comprising further adding 5˜100 parts by weight of clay and mixing them,

(7) a rubber composition as defined in the above (1) through (6) which is used for water supply pipe lines,

(8) a rubber composition as defined in the above (1) through (6) which is used for manufacturing parts of water supply pipe lines,

(9) A rubber manufactured from a rubber composition as defined in any of the above (1)˜(6), and

(10) Parts for water supply and drainage pipe lines comprising using a rubber composition as described in any of the above (1) through (6).

### BRIEF DESCRIPTION OF THE DRAWINGS

FIGS. 1(A)˜(D) are photomicrographs showing outward appearances of a sample (Example 3) before and after the chlorine resistance test.

FIGS. 2(A)˜(D) are photomicrographs showing outward appearances of a sample (Comparative Example 2) before and after the chlorine resistance test.

FIGS. 3(A)˜(D) are photomicrographs showing outward appearances of a sample after the repeated bending test.

### BEST MODE FOR IMPLEMENTING THE INVENTION

A rubber composition according to the present invention is that comprising at least a rubber component, polybutene and white carbon.

Rubber Components

Examples of rubber components usable in the rubber composition of the present invention are isoprene rubber, 1,2-polybutadiene, chloroprene rubber (CR), butyl rubber, styrene-butadiene rubber, nitrile rubber, ethylene-propylene rubber (EPDM), chlorosulfonated polyethylene, epichlorohydrine rubber, acryl rubber, fluorinated rubber, etc. Halogenated derivatives thereof (e.g. chlorinated butyl rubber (CIIR), brominated butyl rubber (BrIIR), etc.) can be also used.

Among the above-described rubber components, EPDM, CIIR or BrIIR is preferably used. More specifically, an example of EPDM is EP-33 (trade name) (Nippon Synthetic (Gosei) Rubber), that of CIIR is 1066 (trade name) (Nippon Butyl), and that of BrIIR is BBX2 (trade name) (Bayer).

The composition of the present invention comprises, in addition to the above-described rubber components, polybutene and white carbon as the essential component.

Polybutene

Addition of polybutene to the rubber component improves the chlorine resistance of the rubber composition. That is, it becomes possible to provide a rubber composition which is able to prevent parts for the water supply and drainage pipe line from the deterioration due to chlorine even in high concentrations of sterilizing chlorine in tap water, and avoid the decrease in their strength.

Amount of polybutene to be added is preferably 5˜60 parts by weight per 100 parts by weight of the rubber component, more preferably 5˜40 parts by weight. An example of polybutene usable in the present invention is 5H (trade name, molecular weight about 400) (Idemitsu Petrochemical Industry (Sekiyu Kagaku)).

White Carbon

Addition of white carbon (silica) to the rubber component improves the flexibility of the rubber composition. That is, it becomes possible to provide a rubber composition made sufficiently strong to endure the repeated displacement.

Amount of white carbon to be added is preferably 5˜100 parts by weight per 100 parts by weight of the rubber component, more preferably 10˜50 parts by weight. An example of white carbon usable in the present invention is Nippuseal VN3 (trade name, specific gravity 1.9˜2.0, SiO₂ content more than 93%, ignition loss 5˜6%, and pH 5.5˜6.5).

A rubber composition of the present invention may contain components other than the rubber component, the polybutene and the white carbon, such as silane coupler and clay as one of preferred embodiments.

Silane Coupler

Addition of a silane coupler to the rubber component improves the reinforcement capability of white carbon which is inferior to carbon black. Specifically, it becomes possible to provide a rubber composition made sufficiently strong against the tensile stress.

Amount of silane coupler to be added is preferably 0.5˜8 parts by weight per 100 parts by weight of the rubber component, more preferably 0.5˜6 parts by weight. In the present invention, it is preferable to use γ-glycidoxypropyl-trimethoxysilane as the silane coupler. A more specific example thereof is A-187 (trade name) (Nippon Unichika).

A rubber composition of the present invention also preferably contains clay (aluminum silicate) as the filler. Amount of clay to be added is preferably 5˜100 parts by weight per 100 parts by weight of the rubber component, more preferably 10˜60 parts by weight. An example of clay which can be used in the present invention is Silicalite (trade name, specific gravity 2.58, apparent specific gravity 0.25 g/cc, average particle diameter 1.5 μm, 325 mesh throughout, water content less than 1.0%, pH 8.0, SiO₂ content 40.78%, Al₂O₃ content 24.43%, MgO content 23.40%, flat shape) (Takehara Chemical Industry).

A rubber composition of the present invention may include an additive that is usually contained in the rubber composition in addition to those described above such as a vulcanization accelerator

Vulcanization Accelerator

Examples of vulcanization accelerators which can be used in the rubber composition of the present invention are N-cyclohexyl-2-benzothiazyl sulfenamide (CBS), dibenzothiazyl disulfide (MBTS), tetramethylthiuram disulfide (TMTD), etc.

More specific examples of the above-described vulcanization accelerators are Accel CZ (trade name) for CBS, Accel DM (trade name) for CBS, and Accel TMT (trade name) for TMTD (all from Kawaguchi Chemical Industry).

A rubber composition of the present invention may include, in addition to the above-described vulcanization accelerators, vulcanizers (such as sulfur), vulcanization activators (such as fatty acids including stearic acid, zinc oxide, etc.), etc.

In Table 1 are shown examples of specific compositions in rubber compositions of the present invention in the case where EPDM, CIIR and BrIIR are used as the rubber component.

TABLE 1

| | | A | B | C |
|---|---|---|---|---|
| Rubber | EPDM | 100 | — | — |
| component | CIIR | — | 100 | — |
| | BrIIR | — | — | 100 |
| Zinc oxide (ZnO) | | 2˜5 | 2˜10 | 2˜10 |
| Stearic acid | | 0.5˜3 | 0.5˜3 | 0.5˜3 |
| Polybutene | | 5˜60 | 5˜60 | 5˜60 |
| Clay | | 5˜100 | 5˜100 | 5˜100 |
| Vulcanizer (S) | | 0.2˜4 | 0.5˜3 | 0.2˜4 |
| Vulcanization | CBS | 1˜4 | — | — |
| accelerator | MBTS | — | 1˜3 | — |
| | TMTD | — | — | 0.5˜3 |
| White carbon | | 5˜100 | 5˜100 | 5˜100 |
| Silane coupler | | 0.5˜8 | 0.5˜8 | 0.5˜8 |

Unit: weight part
EPDM: ethylene-propylene rubber; CIIR: chlorinated butyl rubber; BrIIR: brominated butyl rubber.
CBS: N-cyclohexyl-2-benzothiazyl sulfenamide MBTS: dibeuzothiazyl disulfide TMTD: tetramethylthiuram disulfide.

As shown in the column A of Table 1, in the case where EPDM is used as the rubber component, a rubber composition of the present invention can be constructed by adding, per 100 parts by weight of EPDM, 2˜5 parts by weight of zinc oxide (vulcanization activator), 0.5˜3 parts by weight of stearic acid (vulcanization activator), 5˜60 parts by weight of polybutene, 5˜100 parts by weight of clay, 0.2˜4 parts by weight of sulfur (vulcanizer), 1˜4 parts by weight of CBS (vulcanization accelerator), 5˜100 parts by weight of white carbon, and 0.5˜8 parts by weight of silane coupler, and mixing them.

As shown in Column B of Table 1, in the case where CIIR is used as the rubber component, a rubber composition of the present invention can be constructed by adding, per 100 parts by weight of CIIR, 2˜10 parts by weight of zinc oxide (vulcanization activator), 0.5˜3 parts by weight of stearic acid (vulcanization activator), 5˜60 parts by weight of polybutene, 5˜100 parts by weight of clay, 0.5˜3 parts by weight of sulfur (vulcanizer), 1˜3 parts by weight of MBTS (vulcanization accelerator), 5˜100 parts by weight of white carbon, and 0.5˜8 parts by weight of silane coupler, and mixing them.

Furthermore, as shown in Column C of Table 1, in the case where BrIIR is used as the rubber component, a rubber composition of the present invention can be constructed by adding, per 100 parts by weight of BrIIR, 2˜10 parts by weight of zinc oxide (vulcanization activator), 0.5˜3 parts by weight of stearic acid (vulcanization activator), 5˜60 parts by weight of polybutene, 5˜100 parts by weight of clay, 0.2˜4 parts by weight of sulfur (vulcanizer), 0.5˜3 parts by weight of TMTD (vulcanization accelerator), 5˜100 parts by weight of white carbon, and 0.5˜8 parts by weight of silane coupler, and mixing them.

As described above, since rubber compositions of the present invention can give rise to rubbers with a sufficient strength to endure repeated displacement and excellent chlorine resistance, they are extremely suitable for water supply pipes. Furthermore, parts for water supply pipes comprising rubber compositions of the present invention are strong enough even without burying tire cords comprising nylon, polyesters, etc. and metal wires as reinforcement fibers. That is, rubber compositions of the present invention can be preferably used as those for manufacturing parts of water supply pipes.

### EXAMPLES

In the following, the present invention will be further described with reference to examples. However, the present invention is limited neither to composition ratios of components shown in examples nor to these examples.

### Examples 1˜3 and comparative examples 1˜3

Preparation of Rubber Compositions

First, rubber compositions in examples 1˜3 and comparative examples 1˜3 having composition ratios as shown in Table 2 were prepared.

TABLE 2

| | | | | | Comparative | Comparative | Comparative |
|---|---|---|---|---|---|---|---|
| | | Example 1 | Example 2 | Example 3 | example 1 | example 2 | example 3 |
| Rubber | EPDM | 100 | — | — | 100 | — | 100 |
| component | CIIR | — | 100 | — | — | — | — |
| | BrIIR | — | — | 100 | — | — | — |
| | CR | — | — | — | — | 100 | — |
| Zinc oxide | | 2˜5 | 2˜5 | 2˜5 | 5 | 5 | 5 |
| (ZnO) | | | | | | | |
| Stearic acid | | 0.5˜2 | 0.5˜2 | 0.5˜2 | 1 | 1 | 1 |
| Polybutene | | 5˜40 | 5˜40 | 5˜40 | — | — | 5˜40 |
| Processing oil | | — | — | — | 15 | 15 | 15 |
| Clay | | 10˜60 | 10˜60 | 10˜60 | — | 30 | — |
| Vulcanizer | | 0.5˜3 | 0.5˜3 | 0.5˜3 | — | — | — |
| (S) | | | | | | | |
| Vulcanization | CBS | 1˜3 | — | — | 2 | — | 2 |
| accelerator | MBTS | — | 1 | 1 | — | — | — |
| | TMTD | — | — | 0.5 | — | — | — |
| | EU | — | — | — | — | 0.3 | — |
| White carbon | | 10˜50 | 10˜50 | 10˜50 | — | 10 | — |
| Carbon black | | — | — | — | 45 | 30 | 45 |
| Silane | | 0.5˜6 | 0.5˜6 | 0.5˜6 | — | — | — |
| coupler | | | | | | | |

Unit: weight part
EPDM: ethylene-propylene rubber; CIIR: chlorinated butyl rubber; BrIIR: brominated butyl rubber; CR: chloroprene rubber.
CBS: N-cyclohexyl benzothiazyl sulfenamide; MBTS: benzothiazyl disulfide; TMTD: tetramethylthiuram disulfide; EU: 2-mercaptoimidazoline

Following commercial products were used as the rubber component: EP-33 (trade name) (Nippon Synthetic Rubber) as EPDM; 1066 (trade name) (Nippon Butyl) as CIIR; BBX2 (trade name) (Bayer) as BrIIR; and PM-40 (trade name) (Electrochemical Industry) as CR (chloroprene rubber), respectively.

Following commercial products were used as other components of rubber compositions of the present invention: 5H (trade name, M.W. about 400) (Idemitsu Petrochemical Industry) as polybutene; Nippuseal VN3 (trade name, specific gravity 1.9 2.0, Sio₂ content more than 93%, ignition loss 5˜6%, pH 5.5˜6) (Nippon Silica) as white carbon; Sheasto 3 (trade name, specific gravity 1.8, average particle diameter 26˜30 μm, surface area 80˜100 m²/g, and pH 7˜9, and capacity of oil absorption 1.1˜1.4 cc/g).

Following commercial products were used furthermore as other components of rubber compositions of the present invention: γ-glycidoxypropyl-trimethylsilane (Nihon Unica, A-187 (trade name)) as the silane coupler; Silicalite (trade name, specific gravity 2.58, apparent specific gravity 0.25 g/cc, average particle diameter 1.5 μm, 325 mesh throughout, water content less than 1.0%, pH 8.0, SiO₂ content 40.78%, Al₂O₃ content 24.43%, MgO content 23.40%, flat shape) (Takehara Chemical Industry) as clay.

Following commercial products were used as the vulcanization accelerators: ACCEL CZ (trade name) as CBS, ACCEL DM (trade name) as MBTS; ACCEL TMT (trade name) as TMTD, and ACCEL 22-S (trade name) as EU (2-mercapto-imidazoline) (all from Kawaguchi Chemical Industry).

A. Chlorine Resistance Test

A1. Sample

Rubbers manufactured from rubber compositions according to Example 3 and Comparative example 2 were used as the sample.

A2. Test Method

Samples were placed under the conditions where the chlorine concentration was 3000 ppm at room temperature (23° C.) or 30° C., and changes in hardness, weight and surface area of respective samples were measured.

A3. Test Results

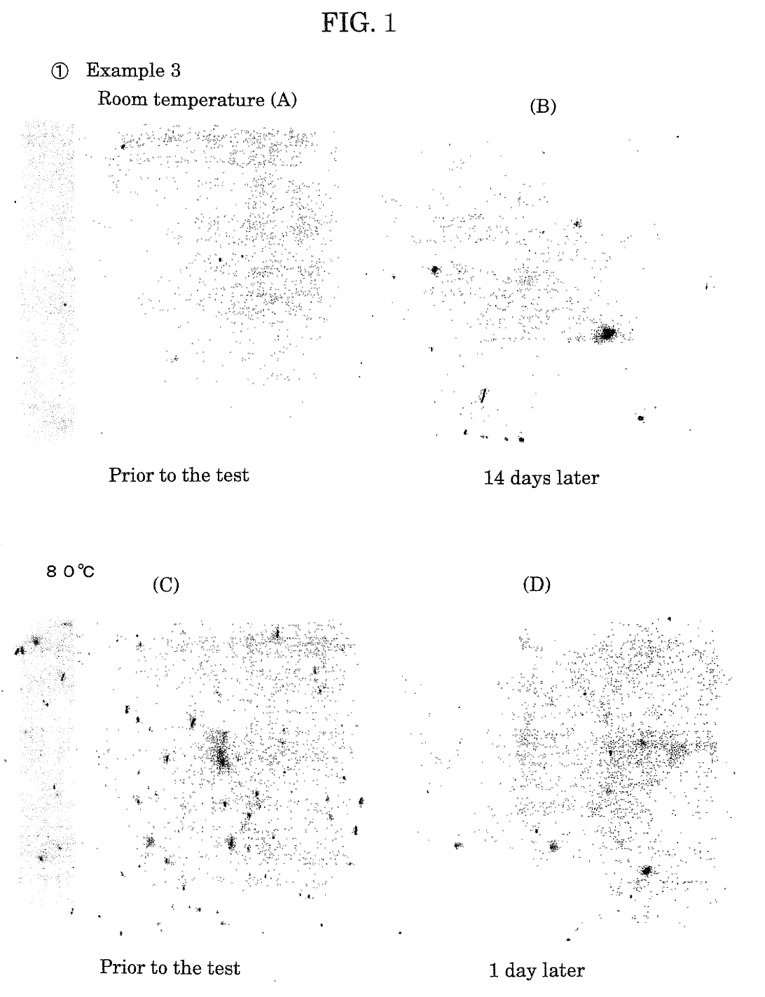

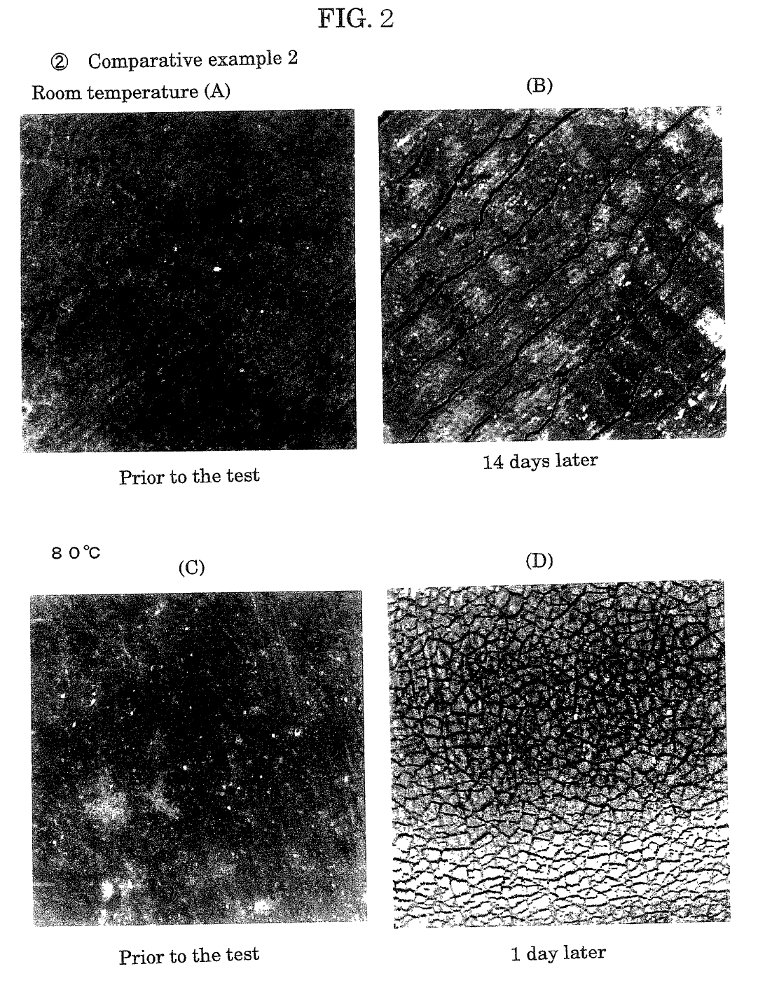

Changes in hardness and weight of samples are shown in tables 3 and 4, respectively. Outward appearances of these samples before and after the tests are also shown in FIGS. 1 (A)˜(D) and FIGS. 2(A)˜(D), respectively. Hardness is measured in accordance with JIS 6253, and a hardness meter of type was used for the measurement. A FIGS. 1(A)˜(D) and FIGS. 2 (A)˜(D) are both shown in 50 times magnification.

TABLE 3

| | | Prior to | 1 day | 5 days | 11 days | 14 days |
|---|---|---|---|---|---|---|
| Example 3 | | test | later | later | later | later |
| Hardness | (Room | 62 | 62 | 58 | 58 | 56 |
| | temperature) | | | | | |
| | (80° C.) | 62 | 58 | — | — | — |
| Weight | (Room | — | 3.7% | 10.9% | 15.3% | 20.6% |
| gain | temperature) | | | | | |
| | (80° C.) | | 3.7% | | | |

TABLE 4

| | | Prior to | 1 day | 5 days | 11 days | 14 days |
|---|---|---|---|---|---|---|
| Comparative example 2 | | test | later | later | later | later |
| Hardness | (Room | 54 | 50 | 48 | 50 | 50 |
| | temperature) | | | | | |
| | (80° C.) | 54 | 47 | — | — | — |
| Weight | (Room | — | 7.6% | 17.5% | 26.3% | 35.9% |
| gain | temperature) | | | | | |
| | (80° C.) | — | 17.6% | — | — | — |

FIGS. 1(A)˜(D) demonstrate that no ruptures occurred in rubbers obtained from rubber compositions according to Example 3 even after the test, while FIGS. 2(A)˜(D) demonstrate that ruptures occurred in rubbers obtained from rubber compositions according to Comparative Example 2 after the test. Furthermore, comparison of tables 3 and 4 clearly show that both decreases in hardness and increase in weight are significant in rubbers obtained from rubber compositions according to Comparative Example 2 as compared with rubbers obtained from rubber compositions according to Example 3.

B. Repeated Bending Test

B1. Test Samples

Rubbers manufactured from rubber compositions according to examples 1 and 2, and comparative examples 1 and 3 were cut into 20 mm wide pieces, and used as test samples.

B2. Test Method

While one end of a test sample piece to which a cut was made in the center was fixed, the other end was repeatedly bent upward and downward to measure the length of rupture(s) formed by these reciprocating motions. These reciprocating motions were applied to the surface of 18˜60 mm wide of the sample 150 times per min (500000 times in total).

B3. Test results

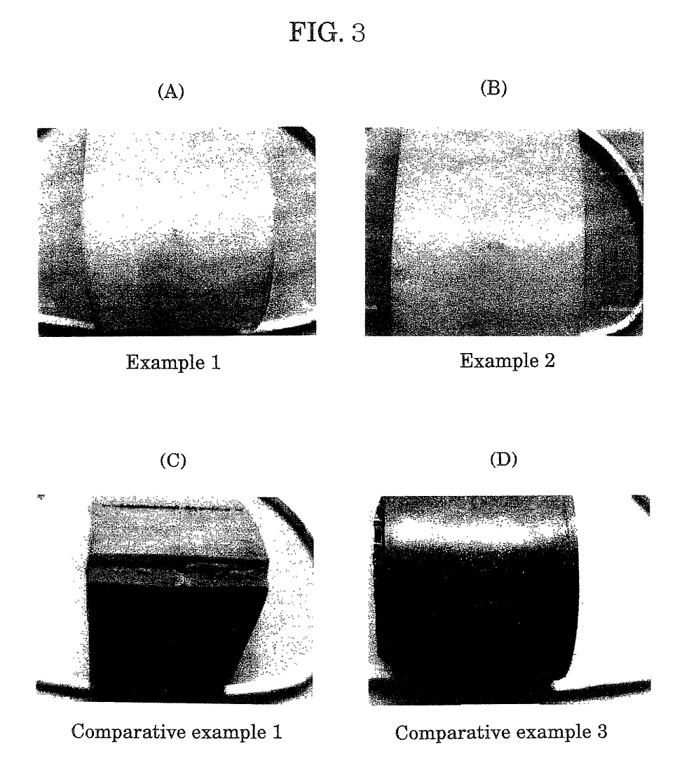

In Table 5 are shown lengths of cuts made in the center of samples prior to the test, and those of ruptures generated by repeated dislocation (bending), respectively. Outward appearances of samples after the test are also shown in FIGS. 3(A)˜(D), respectively.

TABLE 5

| | | | Comparative | Comparative |
|---|---|---|---|---|
| | Example 1 | Example 2 | example 1 | example 2 |
| Prior to test | 1.6 | 2.6 | 1.8 | 2.1 |
| After 50000 | 1.6 | 2.6 | 19.4 | 6.3 |
| times | | | | |
| repeated | | | | |
| bending | | | | |

Unit: mm

The above-described Table 5 and FIGS. 3(A) through (D) demonstrate that no rupture occurred in rubbers obtained from rubber compositions according to examples 1 and 2 by repeated dislocation (bending) different from those in comparative examples 1 and 3.

Industrial Applicability

As described above, with rubber compositions according to the present invention, rubbers having sufficient strength to endure repeated bending and excellent chlorine resistance can be obtained.

1. A rubber composition comprising a rubber component, polybutene and a white carbon.

2. A rubber composition as defined in claim 1 further comprising a silane coupler.

3. A rubber composition as defined in claim 1 further comprising a clay.

4. A rubber composition as defined in claim 1, comprising adding 5˜60 parts by weight of polybutene and 5˜100 parts by weight of white carbon to 100 parts by weight of the rubber component and mixing them.

5. A rubber composition as defined in claim 4 comprising further adding 0.5˜8 parts by weight of silane coupler and mixing it.

6. A rubber composition as defined in claim 4 comprising further adding 5˜100 parts by weight of clay and mixing it.

7. A rubber composition as defined in claim 1, wherein said rubber composition has a shape of a water supply pipe.

8. A rubber composition as defined in claim 1, wherein said rubber composition has a shape of a part of a water supply pipe.

9. A rubber manufactured from a rubber composition as defined in any of claims 1 through 6.

10. A part for a water supply pipe manufactured using a rubber composition described in claim 1.
